(19) United States
(12) Patent Application Publication
(10) Pub. No.: US 2015/0186068 A1
(43) Pub. Date: Jul. 2, 2015

(54) COMMAND QUEUING USING LINKED LIST QUEUES

(71) Applicant: SanDisk Technologies Inc., Plano, TX (US)

(72) Inventors: Shay Benisty, Beer Sheva (IL); Yair Baram, Metar (IL)

(73) Assignee: SanDisk Technologies Inc., Plano, TX (US)

(21) Appl. No.: 14/141,587

(22) Filed: Dec. 27, 2013

(51) Int. Cl. G06F 3/06

(52) U.S. Cl. CPC G06F 3/0638; G06F 3/0604; G06F 3/0673

(57) ABSTRACT

A method, apparatus, and system may be provided for queuing storage commands. A command buffer may store storage commands for multiple command queues. Linked list controllers may control linked lists, where each one of the linked lists identifies the storage commands that are in a corresponding one of the command queues. The linked list storage memory may store next command pointers for the storage commands. A linked list element in any of the linked lists may include one of the storage commands stored in the command buffer and a corresponding one of the next command pointers stored in the linked list storage memory.

### BACKGROUND

1. Technical Field

This application relates to storage systems.

2. Related Art

A host may include a processor, such as a Central Processing Unit (CPU), and a host controller. A storage device controller may be part of a storage system that stores and retrieves data on behalf of the host. The storage device controller may receive storage commands from the host controller. The storage device controller may process the storage commands, and, where applicable, return a result and/or data to the host. In some examples, the storage commands may conform to a storage protocol standard, such as a Non Volatile Memory Express (NVME) standard. The NVME standard describes a register interface, a command set, and feature set for PCI Express (PCIE®)-based Solid-State Drives (SSDs). PCIE is a registered trademark of PCI-SIG Corporation of Portland, Oreg.

### SUMMARY

A storage system may be provided that includes a command buffer, linked list controllers, and a linked list storage memory. The command buffer may store storage commands for multiple command queues. Each one of the linked list controllers may control a corresponding one of multiple linked lists. Each one of the linked lists may be for a corresponding one of the command queues. The linked list storage memory may store next command pointers for the storage commands, which are stored in the command buffer. A linked list element in any of the linked lists may include one of the storage commands stored in the command buffer and a corresponding one of the next command pointers stored in the linked list storage memory. The storage command and the next command pointer may be included in the linked list element based on a correspondence between an address at which the storage command is stored in the command buffer and an address at which the corresponding next command pointer is stored in the linked list storage memory.

An apparatus may be provided that includes a linked list storage memory that stores next command pointers for storage commands. The storage commands may be stored in a command buffer. Each one of the storage commands stored in the command buffer may be queued in one of multiple command queues. Each one of multiple linked lists may identify the storage commands that are in a corresponding one of the command queues. A linked list element in any of the linked lists may include a respective one of the storage commands stored in the command buffer and a corresponding one of the next command pointers stored in the linked list storage memory. The linked list controller may include the respective one of the storage commands and the corresponding one of the next command pointers in the linked list element based on storage of the corresponding one of the next command pointers in the linked list storage memory at an address that corresponds to an address of the one of the storage commands stored in the command buffer.

A method is provided for storage command queuing. Storage commands may be stored in a command buffer when the storage commands are queued in a plurality of command queues. Next command pointers may be stored in a linked list storage memory, where each respective one of the next command pointers identifies a storage command that follows a corresponding one of the storage commands in a corresponding one of the queues. Each respective one of the next command pointers may be associated with the corresponding one of the storage commands by storing each respective one of the next command pointers at an address in the linked list storage memory that corresponds to an address at which the corresponding one of the storage commands is stored in the command buffer.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a command queuing system;

FIG. 2 illustrates an example of an implementation of queues;

FIG. 3A illustrates states of an implementation of queues when a queue and a corresponding linked list is empty;

FIG. 3B illustrates states of an implementation of queues after a first command is added to a queue;

FIG. 3C illustrates states of an implementation of queues after a second command is added to a queue;

FIG. 3D illustrates states of an implementation of queues after a third command is added to a queue;

FIG. 3E illustrates states of an implementation of queues after a fourth command is added to a queue;

FIG. 3F illustrates states of an implementation of queues after a first command is removed from a queue;

FIG. 4 illustrates a block diagram of linked list storage memory; and

FIG. 5 illustrates an example flow diagram of the logic of the system.

### DETAILED DESCRIPTION

The NVME standard provides a queuing interface through which storage commands may be queued in host memory. For example, a host may issue a command for execution by adding the command to a submission queue in host memory and updating a submission queue doorbell register to indicate that the command has been added to the submission queue. A storage device controller in a storage device may fetch the command from the submission queue that is in the host memory. After fetching the command, or otherwise receiving the command from the host, the storage device controller may indicate to a device back end controller that the command is ready for execution.

Upon completion of a command arbitration mechanism, the storage device controller may proceed with executing the command. The command arbitration mechanism facilitates the storage device controller executing commands in an order different than the order in which the commands were received. After the command is executed, the storage device controller may write a completion queue entry to a completion queue in the host memory indicating that the command has been executed. Next, the device controller may generate an interrupt to indicate to the host that the completion queue entry in the completion queue is ready to be processed at the host.

In response to the interrupt, the host may read and process the completion queue entry from the completion queue. Processing the completion queue entry may include performing an action based on an indication that the command executed successfully. Alternatively or in addition, processing the completion queue entry may include performing an action based on an error condition that may have been encountered. Finally, the host may write to a completion queue doorbell register to indicate that the completion queue entry has been processed.

By using the queues such as those described in the NVME standard, one or more applications running in the host may have more than one I/O commands pending at a time. The multiple I/O commands may be pending because NVME uses asynchronous Input/Output (I/O). In asynchronous I/O, a programmatic procedure that reads from or writes to a file or other unit of storage may return before the read or write is executed. In contrast, a programmatic procedure that reads from or writes to a file using synchronous I/O may not return until after the read or write is executed.

According to the NVME standard, a queue level may be set indicating how many storage commands at a time may be queued in a queue. Queue management operations described by the NVME standard may also be performed such as allocating, deleting and coordinating the queues.

When fetching a command from a submission queue, the storage device controller may parse the command, classify the command, and queue the command to an appropriate device queue. The classification may depend on the type and/or attributes of the command. The device queues may include one or more firmware queues for commands to be executed by firmware. The device queues may include one or more hardware queues for commands to be executed by hardware. The device queues may include one or more dependency queues for commands that may not be executed until other commands are executed first.

The NVME standard supports queuing a substantial number of commands concurrently. For example, the NVME standard may support queuing up to two to the power of 32 commands at once. Each embodiment may support queing up to a maximum theoretical amount described in the NVME standard. Alternatively or in addition, each embodiment may support queuing a practical number of commands concurrently. For example one embodiment may support queuing 100 commands concurrently. In many scenarios, the multiple commands may be distributed across multiple device queues. However, in a worst case scenario, all or most of the commands may be queued in one of the device queues. Therefore, each of the device queues may have to support queuing up to a maximum number of commands that may be queued under the NVME standard or other such standard.

Methods and systems are presented to queue commands without requiring enough memory to queue the maximum number of commands in each queue concurrently. One technical advantage of the presented methods and systems may be that less total memory may be required to implement the queues than for other method and systems of queuing commands. Another technical advantage of the presented methods and system may be that queuing operations may be performed faster than other method and systems of queuing commands. Still another technical advantage may be the simplicity in removing a command from inside a queue, such as when handling an abort command. Some embodiments may have different advantages than other embodiments.

In one example, a storage system may be provided that includes a command buffer, linked list controllers, and a linked list storage memory. The command buffer may store storage commands for multiple command queues. The command queues may be device queues.

Each one of the linked list controllers may control a corresponding one of multiple linked lists. Each one of the linked lists may be for a corresponding one of the command queues. For example, one of the linked list controllers may control a linked list that identifies the commands that are queued to a firmware queue.

The linked list storage memory may store next command pointers for the storage commands that are stored in the command buffer. A linked list element in any of the linked lists may include: (1) one of the storage commands that is stored in the command buffer and (2) a corresponding one of the next command pointers stored in the linked list storage memory. In some examples, the linked list element may include additional, fewer, or different components. The storage command and the next command pointer may be included in the linked list element based on a correspondence between an address at which the storage command is stored in the command buffer and an address at which the corresponding next command pointer is stored in the linked list storage memory.

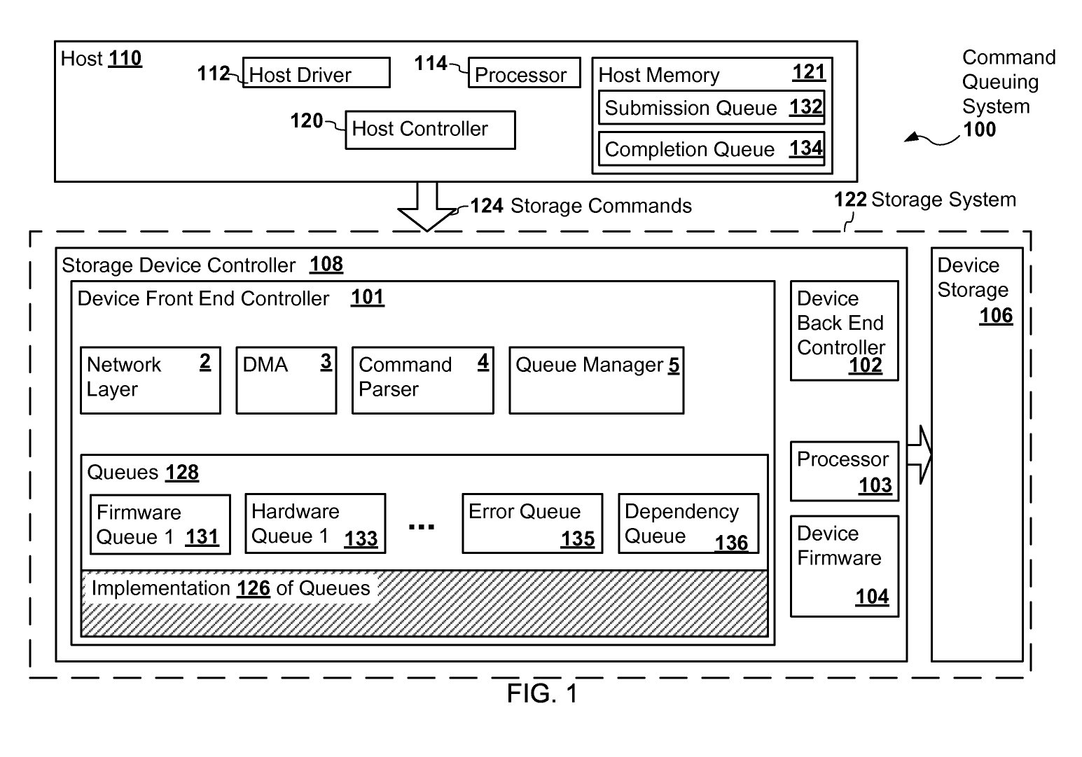

FIG. 1 illustrates an example of a command queuing system 100. The system 100 may include a storage device controller 108 and a host 110. The host 110 may be a computer, a laptop, a server, a mobile device, a cellular phone, a smart phone, or any other type of processing device. The host 110 may include a host driver 112, a processor 114, a host controller 120, and host memory 121. The host driver 112 may be executable by the processor 114.

The storage device controller 108 may be part of a storage system 122. The storage system 122 may include the storage device controller 108 and device storage 106, such as flash memory, optical memory, magnetic disc storage memory, or any other type of computer readable memory.

The host controller 120 may be a hardware component that implements a storage protocol for the host 110. The host controller 120 may interact with the storage system 122 and be controlled by the host driver 112. For example, the host controller 120 may process storage commands 124 received from the host driver 112. The host controller 120 may include a microcontroller or any other type of processor. The host controller 120 may handle communications with the storage device controller 108 in accordance with the storage protocol. Examples of the host controller 120 may include a NVME host controller, a Serial Advanced Technology Attachment (also known as a Serial ATA or SATA) host controller, a SCSI (Small Computer System Interface) host controller, a Fibre Channel host controller, an INFINIBAND® host controller (INFINIBAND is a registered trademark of System I/O, Inc. of Beaverton, Oreg.), a PATA (IDE) host controller, or any other type of host storage device controller that may process the storage commands 124.

The storage device controller 108 may be a hardware component that communicates with the host controller 120 on behalf of the storage system 122, queues the storage commands 124, and controls the device storage 106. The storage device controller 108 may handle communications with the host controller 122 in accordance with a storage protocol. For example, the storage device controller 108 may process the storage commands 124 transmitted to the storage system 122 by the host controller 120, where the storage commands 124 conform to the storage protocol. Examples of the storage protocol may include NVME, Serial Advanced Technology Attachment (also known as a Serial ATA or SATA), SCSI (Small Computer System Interface), Fibre Channel, INFINIBAND® (INFINIBAND is a registered trademark of System I/O, Inc. of Beaverton, Oreg.), PATA (IDE), or any protocol for communicating data to a storage device.

Each of the storage commands 124 may be any data structure that indicates or describes an action that the storage device controller 108 is to perform or has performed. The storage commands 124 may be commands in a command set described by the NVME standard or any other storage protocol. Examples of the storage commands 124 may include Input/Output (I/O) commands and administrative commands. Examples of the I/O commands may include a write command that writes one or more logical data blocks to storage, a read command that reads one or more logical data blocks from storage, or any other command that reads from and/or writes to storage. The administrative commands may be any command for performing administrative actions on the storage. Examples of the administrative commands may include an abort command, a namespace configuration command, and/or any other command related to management or control of data storage. The storage commands 124 may be a fixed size. Alternatively or in addition, the storage commands 124 may be a variable size.

The storage device controller 108 may include a device front end controller 101, a device back end controller 102, a processor 103, and device firmware 104. The device back end controller 102 may interact with the device storage 106. For example, the device back end controller 102 may include a memory controller, such as a flash memory controller. The device firmware 104 may be executable with the processor 103 to process one or more types of the storage commands 124. For example, the firmware may be executable to process the commands 124 that are not executable by the device back end controller 102.

The device front end controller 101 may be a component that handles communication with the host controller 120. The device front end controller 101 may include a network layer 2, a direct memory access component (DMA) 3, a command parser 4, a queue manager 5, and an implementation 126 of queues 128. The network layer 2 may include a mac layer, a physical layer, and/or any other network communication logic. The DMA 3 may be a component for copying memory to and/or from the host 110. For example, the DMA 3 may read data from and/or write data to the host memory 121. The data may be one or more of the storage commands 124.

The queues 128 may be first-in, first-out (FIFO) queues. The queues 128 may include a submission queue 132, a completion queue 134, a firmware queue 131, a hardware queue 133, an error queue 135, a dependency queue 136, or any other type of queue. The queues 128 may include one or more types of queues, and any number of each type of queue. The queues 128 may include device queues that are included in the storage system 122 or storage device, such as the firmware queue 131 and the hardware queue 133. The queues 128 may include host queues that are included in the host 110, such as the submission queue 132 and the completion queue 134.

The implementation 126 of the queues 128 in the storage device controller 108 may include an implementation of the device queues. In contrast, the host queues are implemented in the host 110. The host queues may be implemented in the host 110 in the same manner in which the device queues 128 are implemented in the storage device controller 108. Alternatively, the host queues may be implemented in the host 110 differently than the device queues 128 are implemented in the storage device controller 108.

The firmware queue 131 may queue the storage commands 124 that are executed by the device firmware 104. The hardware queue 133 may queue the storage commands 124 that are executed by the device back end controller 102. The error queue 135 may queue a data structure that describes an error that was encountered when one or more of the storage commands 124 was executed. The dependency queue 136 may queue the commands 124 that currently cannot be executed due to a dependency on other pending commands.

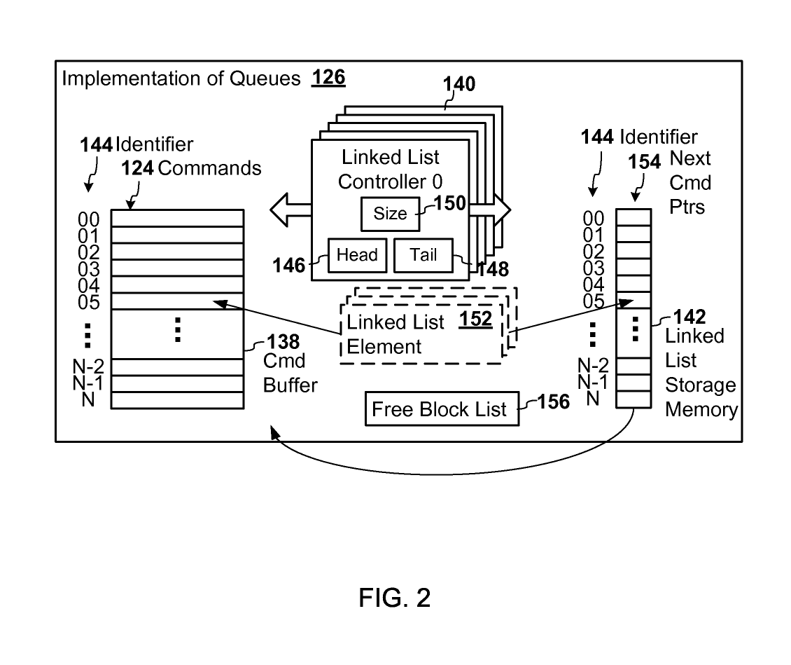

Referring to FIG. 2, the implementation 126 of the queues 128 may include a command buffer 138, a linked list controller 140 for each of the queues 128, and a linked list storage memory 142. The command buffer 138 may be any memory that stores the commands 124 that are queued in the queues 128. In other words, the queues 128 may share the command buffer 138. The command buffer 138 may be a central buffer used by two or more of the queues 128 for storage. The commands 124 in one of the queues 128 may be interspersed in the command buffer 138 with the commands 124 in another one of the queues 128. Examples of the command buffer 138 may include any type of memory, such as dual-ported memory or any other type of random access memory.

Each of the commands 124 that is stored in the command buffer 138 may be identified within the command buffer 138 by an identifier 144. The identifier 144 may be a location, a memory address, or any other identifier that identifies a corresponding one of the commands 124 within the command buffer 138. In one example, the identifiers identifying the commands 124 within the command buffer 138 may be line numbers, where each line number identifies a slot in which a corresponding one of the commands 124 may be stored in the command buffer 138. In a second example, the identifiers may be a series of numbers, where each element of the series differs from the next element in the series by a fixed or variable amount. In a third example, the identifiers may not be numbers. Each one of the identifiers may be unique among the identifiers applicable to the command buffer 138. The address of the command may be a memory address, a location, a line number, a slot number or any other indication of where in the command buffer 138 the command is stored.

The identifier 144 may be a number or other identifier that identifies external and internal resources that the corresponding one of the commands 124 may use when executed. The external resources may be outside of the storage device controller 108. The internal resources may be included in the storage device controller 108. The external resources may be external memories which store relevant information for processing the corresponding command. For example, the identifier 144 may identify a slot in a DRAM that the command identified by the identifier 144 use. The internal resources may include internal flip-flops and/or registers that assist in execution of the command. The identifier 144 may logically identify a storage area that may be used for further execution of the command identified by the identifier 144.

Each one of the linked list controllers 140 may be hardware that controls a linked list for a corresponding one of the queues 128. The linked list may keep track of the commands 124 that are in the queue that corresponds to the linked list. In addition to logic, each one of the linked list controllers 140 may include a head 146, a tail 148, and a size 150. The head 146 may identify a first linked list element in the linked list. The tail 148 may identify a last linked list element in the linked list. The size 150 may indicate the number of the linked list elements that are included in the linked list. The first linked list element may include or identify the command that will be removed next from the queue, and the last linked list element may include or identify the command that was last added to the queue.

Each linked list element 152 in the linked list may be considered a logical construct. Each linked list element 152 may logically include: one of the commands 124 physically stored in the command buffer 138; and one of a collection of next command pointers 154 physically stored in the linked list storage memory 142. The command logically included in the linked list element 152 may be identified by the identifier of the command. Similarly, the next command pointer logically included in the linked list element 152 may also be identified by the identifier 144 of the command in the command buffer 138. Accordingly, the linked list element 152 may be identified by the identifier 144 of the command in the command buffer 138.

In other words, the linked list element 152 in any of the linked lists may include one of the commands 124 stored in the command buffer 138 and a corresponding one of the next command pointers 154 stored in the linked list storage memory 142. The command and the corresponding next command pointer may be logically included in the linked list element 152 based on a correspondence between the identifier 144 of the command stored in the command buffer 138 and the identifier 144 of the corresponding next command pointer 154 stored in the linked list storage memory 142. The correspondence between the identifiers may be that the identifiers are the same value. For example, the command in the command buffer 138 may be stored at an address in the command buffer that equals an address at which the corresponding next command pointer 154 is stored in the linked list storage memory 142. Alternatively or in addition, the correspondence between the identifiers may be that one of the identifiers is a function of the other one of the identifiers, or is otherwise derivable therefrom.

The next command pointer may include the identifier 144 of the next command in the queue corresponding to the linked list. In addition to identifying the next command, the next command pointer 154 may also identify the next linked list element in the linked list.

Any pointer to the linked list element 152 may also be the identifier 144 of the command logically included in the linked list element 152. For example, the head 146 and/or the tail 148 may identify the linked list element 152 using the identifier 144 of the command logically included in the linked list element 152.

During operation of the command queuing system 100, the storage device controller 108 may receive the storage commands 124 from the host 110 destined for the queues 128. The queue manager 5, together with the linked list controllers 140, may add the commands 124 to the queues 128. When any one of the commands 124 is added to the corresponding queue, the queue manager 5 and/or the linked list controller 140 may determine and/or assign the identifier 144 that is to identify the command within the command buffer 138. The identifier 144 may be unique among the identifiers applicable to the command buffer 138 so as to avoid contention issues in the linked list storage memory 142. The identifier 144 may be a location of a free block or slot in the command buffer 138. The block or slot may be free if no currently queued command is stored in the block or slot.

The free block or slot may be determined from a free block list 156 or by some other mechanism. The identifier 144 may be determined in some examples simply as the address of the free block or slot in which the command is added. The free block list 156 may mark slots or numbers that are currently in use and/or not in use. The free block list 156 may be a bitmap register in which each bit represents a slot. When a value of a bit is zero, for example, the bit may indicate that the slot is currently free. Alternatively, when the bit is set, the bit may indicate that the slot is currently in use. The free block list 156 may be updated when assigning the identifier 144 to the command being queued to indicate that the slot or block identified by the identifier 144 is no longer free.

The queue manager 5 and/or the linked list controller 140 may add the command to the command buffer 138 in the free block or slot identified by the identifier 144. The linked list controller 140 may set the next command pointer 154, which is virtually included in the linked list element 152 pointed to by the tail 148, to the identifier 144 of the command just added to the command buffer 138. The linked list controller 140 may update the tail 148 to point to the command just added to the command buffer 138. In other words, the next command pointer 154 at a previous value of the tail 148 is updated to point to a new value of the tail 148, which is the identifier 144 newly assigned by the queue manager 5 and/or the linked list controller 140. The next command pointer 154 at the previous value of the tail 148 is updated by updating the linked list storage memory 142 at a location identified by the previous value of the tail 148 with the new value of the tail 148. The linked list controller 140 may increment the size 150 of the linked list because the command was just added to the linked list.

When the storage device controller 108 removes one of the commands from one of the queues 128 for execution or in response to completed execution of the command, the queue manager 5 and/or the linked list controller 140 may read the command identified by the head 146 from the command buffer 138. The linked list controller 140 may read the next command pointer 154 identified by the head 146 from the linked list storage memory 142. The linked list controller 140 may set the head 146 to the next command pointer 154 read from the linked list storage memory 142. The queue manager 5 and/or the linked list controller 140 may update the free block list 156 to indicate that the block or slot at which the command was removed is free when freeing the identifier 144. The identifier 144 may be freed in response to the command being executed or otherwise removed from the queue. In some examples, the queue manager 5 and/or the linked list controller 140 may free the identifier 144 after the command being removed has had a corresponding entry posted to the completion queue 134 in the host 110.

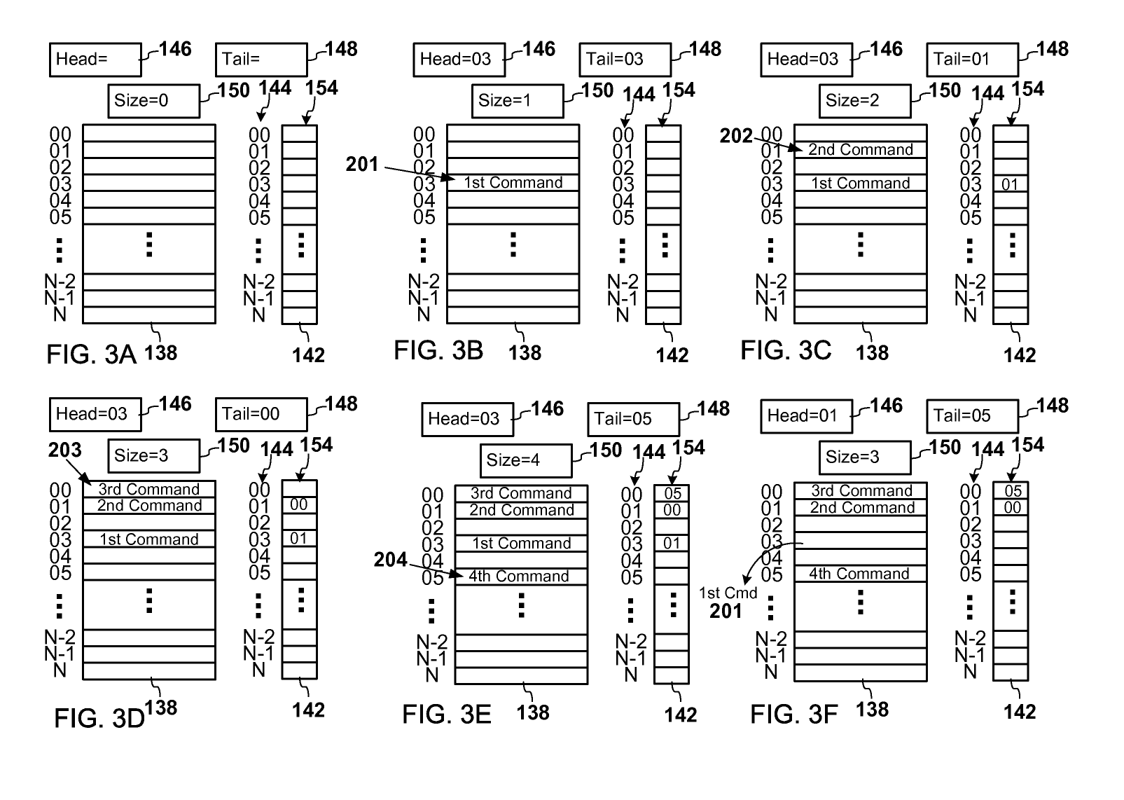

FIGS. 3A to 3F illustrate example states of components of the implementation 126 of the queues 128 as one of the queues 128 is adjusted over time. FIG. 3A illustrates the states when the queue and the corresponding linked list is empty. The size 150 of the linked list, which is stored in the linked list controller 140 for the linked list, is set to zero or some other value indicating that the linked list is empty. The head 146 and the tail 148 of the linked list may or may not be set to a particular value. Because the queue is empty, the command buffer 138 may not include any of the commands 124 currently stored in the queue. On the other hand, the command buffer 138 may include the commands 124 queued in other non-empty queues.

When one of the commands 124 is added to one of the queues 128, the queue manager 5 and/or the linked list controller 140 may determine and/or assign the identifier 144 that is to identify the command within the command buffer 138. The linked list controller 140 may add the command at the tail of the linked list corresponding to the queue. For example, FIG. 3B illustrates the states of the implementation 126 after a first command 201 is added to the queue. The identifier 144 may be determined to identify a free block, such as the block having the identifier 144 “03”. The first command 201 may be stored in the command buffer 138 at the location indicated by the newly assigned identifier 144. The head 146 may also be set to the identifier 144, which is “03”. The tail may also be set to the identifier 144. The next command pointer 154 in the linked list storage memory 142 at a location identified by the identifier 144 “03” may be set to a value indicating that there are no more commands in the queue other than the first command 201. Alternatively, the next command pointer 154 may not be set because the size 150 indicates that the first command 201 is the only command in the queue.

FIG. 3C illustrates the states of the implementation 126 after a second command 202 is added to the queue. The identifier 144 may be determined to identify a free block, such as the block having the identifier 144 “01”. The second command 202 may be stored in the command buffer 138 at a location identified by the identifier 144 “01”. The size 150 may be incremented to the value “2” because two commands are in the queue. The tail 148 may be set to the value “01” identifying the command last added to the queue, which is the second command 202. The next command pointer 154 for the first command 201, which is identified by the identifier 144 “03”, may be set to the identifier 144 of the second command 202, which is the identifier 144 “01”.

FIG. 3D illustrates the states of the implementation 126 after a third command 203 is added to the queue. The identifier 144 may be determined to identify a free block, such as the block having the identifier 144 “00”. The third command 203 may be stored in the command buffer 138 at a location identified by the identifier 144 “00”. The size 150 may be incremented to the value “3” because three commands are in the queue. The tail 148 may be set to the value “00” identifying the command last added to the queue, which is the third command 203. The next command pointer 164 for the second command 202, which is identified by the identifier 144 “01”, may be set to the identifier 144 of the third command 203, which the identifier 144 “00”.

FIG. 3E illustrates the states of the implementation 126 after a fourth command 204 is added to the queue. The identifier 144 may be determined to identify a free block, such as the block having the identifier 144 “05”. The fourth command 204 may be stored in the command buffer 138 at a location identified by the identifier 144 “05”. The size 150 may be incremented to the value “4” because four commands are in the queue. The tail 148 may be set to the value “05” identifying the command last added to the queue, which is the fourth command 203. The next command pointer 164 for the third command 202, which is identified by the identifier 144 “00”, may be set to the identifier 144 of the fourth command 204, which the identifier 144 “05”.

When one of the commands 124 is removed from the queue, the linked list controller 140 may remove the command from the head of the linked list corresponding to the queue. For example, FIG. 3F illustrates the states of the implementation 126 after the first command 201 is removed from the queue. The size 150 of the queue may be decremented to the value “3” because three commands 202, 203, and 204 remain in the queue after the first command 201 is removed. Prior to removing the first command 201, the next command pointer 154 corresponding to the first command 201 identifies the next command in the queue, which was the second command 202. The second command 202 has an identifier 144 “01”. Accordingly, after the first command 201 is removed from the queue, then the head 146 of the linked list may be set to the identifier 144 “01” of the second command 201. The tail 148 may remain unchanged. The block that once held the first command 201, may be freed.

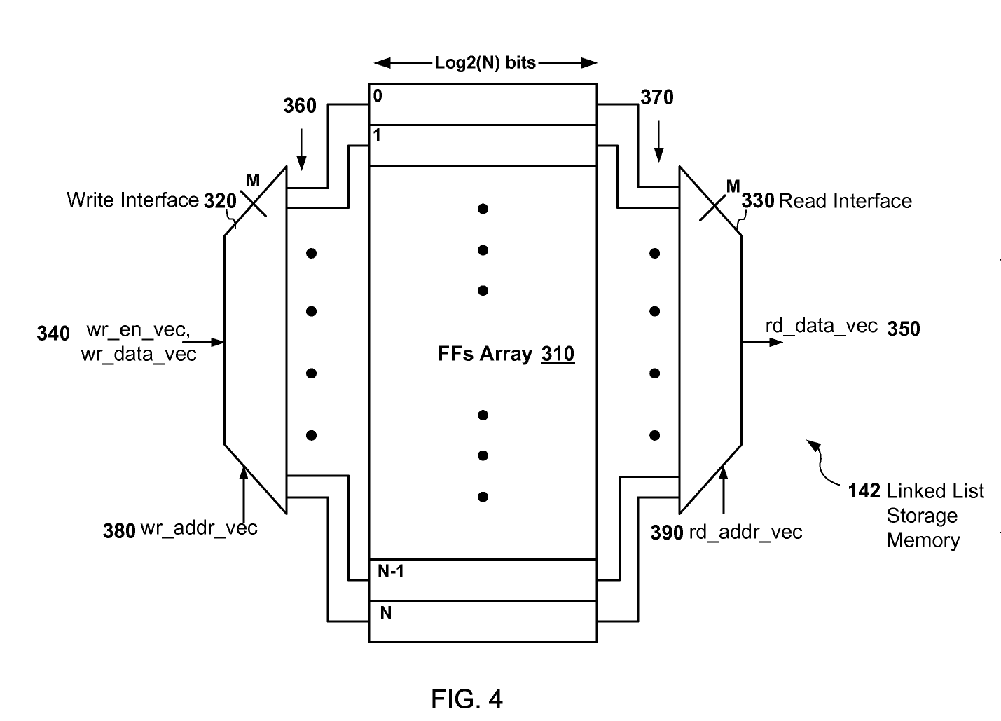

FIG. 4 illustrates a block diagram of the linked list storage memory 142. The linked list storage memory 142 may include a flip flop array 310, a write interface 320 for each of the linked lists or the queues 128, and a read interface 330 for each of the linked lists or the queues 128. Alternatively, the linked list storage memory 142 may include any type of memory instead of the flip flop array 310.

The flip flop array 310 may be an array of flip flops. Each one of the flip flops may store a corresponding bit. The flip flop array 310 may be sized to hold the next command pointers 154. If the command buffer 138 stores up to N commands at once, then the flip flop array 310 may be sized to include N*log₂ (N) flip flops to store N of the next command pointers 154, where each of the next command pointers 154 uses log₂ (N) bits of storage.

Each one of the linked list controllers 140 may use the write interface 320 dedicated to the respective linked list controller 140 for writing data 340 to the flip flop array 310. In addition, each one of the linked list controllers 140 may use the read interface 330 dedicated to the respective linked list controller 140 for reading data 350 from the flip flop array 310. The write interface 320 may be used when pushing a new command to a queue and the size of the queue is more than zero. The read interface 330 may be used when popping a command from a queue and the size of the queue is more than one.

The write interface 320 may be a demultiplexer that forwards the data 340 over a selected set of the lines 360 to selected flip flops in the flip flop array 310. The selected set of the lines 360 may be selected by a write address vector 380, which is designated wr_addr_vec in FIG. 4. When pushing a new command to a queue, the value of the wr_addr_vec may be the previous value of the tail 148. The respective linked list controller 140 may provide the write address vector 380 to the write interface 320. The write address vector 380 may be the identifier 144 or address of the corresponding command stored in the command buffer 138. The respective linked list controller 140 may also provide the next command pointer 154 for the corresponding command as the data 340 to the write interface 320.

The read interface 330 may include a multiplexer that reads the data 350 over a selected set of the lines 370 from selected flip flops in the flip flop array 310. The selected set of the lines 370 may be selected by a read address vector 390, which is designated rd_addr_vec in FIG. 4. The respective linked list controller 140 may provide the read address vector 390 to the read interface 330. The value of the read address vector 390 may be the value of the head 146, for example, because the head 146 may point to the command to be pulled. The read address vector 390 may be the identifier 144 or address of the corresponding command stored in the command buffer 138. The respective linked list controller 140 may receive the next command pointer 154 for the corresponding command as the data 350 outputted by the read interface 330. The next command pointer 154 for the corresponding command may be written to the head 146.

The linked list storage memory 142 may include M write interfaces 320 for M queues or linked lists. Each one of the write interfaces 320 may include a corresponding demultiplexer. The linked list storage memory 142 may include M read interfaces 330 for M queues or linked lists. Each one of the read interfaces 330 may include a corresponding multiplexer.

The linked list storage memory 142 illustrated in FIG. 4 facilitates the queues 128 working simultaneously without any interaction with each other. Using one hardware cycle, the respective linked list controller 140 may add one of the commands to the queue and/or remove the command from the queue. During operation of the linked list storage memory 142, the linked list controllers 140 may write to and/or read from any address of the flip flop array 310 simultaneously. Alternatively, if a type of memory other than the flip flop array 310 is used (such as SRAM) in the linked list storage memory 142, then the linked list controllers 140 may not simultaneously write to and/or read from any address of the flip flop array 310. The identifiers 144 of the commands 124 in each respective one of the queues 128 will be different than the identifiers 144 of the commands 124 in the other queues 128. Accordingly, whenever the linked list controllers 140 read or write to the address 380 or 390 of the command, the linked list controllers 140 will not have contention issues.

The linked list controllers 140 may remove any of the commands 124 from any position in any of the queues 128 by removing the corresponding linked list element 152 from the corresponding queue. The linked list controllers 140 may perform such a removal in response to an abort command, which may require removing the aborted command from the queue. An operation to remove the command may be accomplished by scanning the queue, finding a location of the command needed to be removed, and removing the command from the queue by pointing the command preceding the removed command to the command that follows the removed command in the linked list.

The command queuing system 100 and the storage system 122 may be implemented with additional, different, or fewer components. For example, the system 100 may include a memory that includes the host driver 112. In another example, the system 100 may include just the storage device controller 108. In yet another example, the system 100 may include only the implementation 126 of the queues 126. In some examples, the storage system 122 may not include the storage device controller 130.

An apparatus to queue the storage commands 124 may include any of the components of the storage system 122 and/or the command queuing system 100. For example, the apparatus to queue the storage commands 124 may include the queue manager 5 and the implementation 126 of the queues 126. Examples of such an apparatus may include a storage device, a component or subsystem of a motherboard, a circuit; a chip, or any other hardware component, portion of a hardware component, or combination thereof.

The processor 114 in the host 110 may be in communication with memory comprising the host driver 112. The processor 114 may be a microcontroller, a general processor, central processing unit, server, application specific integrated circuit (ASIC), digital signal processor, field programmable gate array (FPGA), digital circuit, analog circuit, and/or any other device configured to execute logic.

The processor 104 in the storage device controller 108 may be a microcontroller, a general processor, central processing unit, server, application specific integrated circuit (ASIC), digital signal processor, field programmable gate array (FPGA), digital circuit, analog circuit, and/or any other device configured to execute logic. The processor 104 may be in communication with the device firmsware 104, the device front end controller 101, and/or the device back end controller 102.

The processors 104 114 may be one or more components operable to execute logic. The logic may include computer executable instructions or computer code embodied in memory that, when executed by the processor 114, cause the processor 114 to perform the features of the device firmware 104, the features of the host driver 112, and/or any other features.

Each component may include additional, different, or fewer components. For example, each one of the linked list controllers 140 may include the head 146 and the tail 148, but not the size 150. In another example, the implementation 126 of the queues 128 may include additional memory.

The system 100 may be implemented in many different ways. For example, the queues 128 may be a different type of queue than a FIFO queue. In one such example, the queues 128 may be a last-in, first-out (LIFO) queue. In FIG. 1, the implementation 126 of the queues 128 implements devices queues, and is, accordingly, included in the storage device controller 108. In other examples, the implementation 126 of the queues 128 implements host queues, and accordingly, is included in the host 110. Alternatively or in addition, each of the host 110 and the storage device controller 108 may include a respective implementation of the queues in the host 110 and the storage device controller 108, respectively.

The linked lists may be singly linked lists. Alternatively or in addition, the linked lists may be doubly linked lists.

Each module, such as the device front end controller 101, the device back end controller 102, the device firmware 104, the queue manager 5, the linked list controllers 140, the linked list storage memory 142, the write interface 320, and the read interface 330, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of memory that includes the command buffer 138, for example, that comprises instructions executable with a processor, such as the processor 103 in the storage device controller 108, to implement one or more of the features of the module. When any one of the modules includes the portion of the memory that comprises instructions executable with the processor, the module may or may not include the processor. In some examples, each module may just be the portion of the memory that comprises instructions executable with the processor to implement the features of the corresponding module without the module including any other hardware. Because each module includes at least some hardware even when the included hardware comprises software, each module may be interchangeably referred to as a hardware module, such as the device front end hardware controller 101, the device back end hardware controller 102, the device firmware hardware 104, the queue manager hardware 5, the linked list hardware controllers 140, the linked list storage memory hardware 142, the write interface hardware 320, and the read interface hardware 330.

Some features, such as the host driver 112, are shown stored in a computer readable storage medium (for example, as logic implemented as computer executable instructions or as data structures in memory). Some parts of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

The processing capability of the system 100 may be distributed among multiple entities, such as among multiple processors and memories, optionally including multiple distributed processing systems. Parameters, databases, and other data structures, such as the size 150, the head, and/or the tail of each linked list may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library.

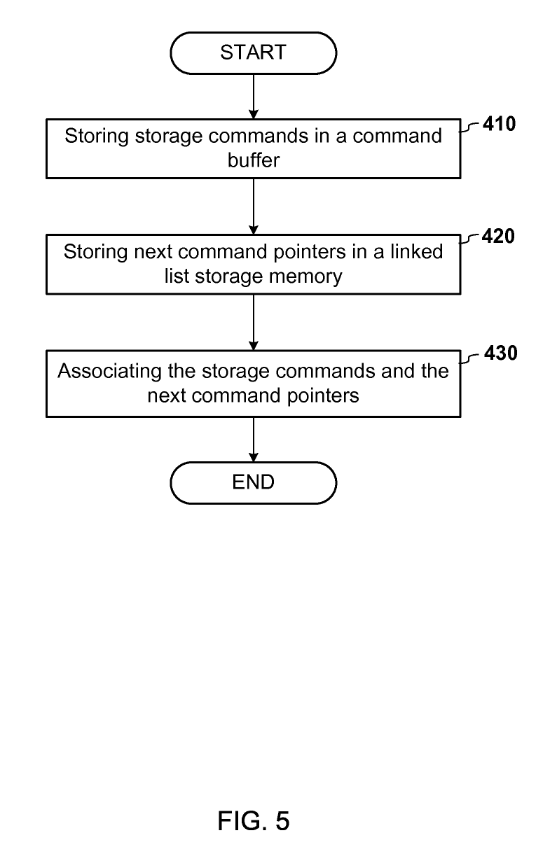

FIG. 5 illustrates an example flow diagram of the logic of the system 100. The operations may be executed in a different order than illustrated in FIG. 5.

The storage commands 124 may be stored (410) in the command buffer 138 when the storage commands 124 are queued in the command queues 128. The next command pointers 154 may be stored (420) in the linked list storage memory 142, where each respective one of the next command pointers 154 identifies the storage command that follows a corresponding one of the storage commands 124 in a corresponding one of the queues 126.

Each respective one of the next command pointers 154 may be associated (430) with the corresponding one of the storage commands 124. To that end, each respective one of the next command pointers 154 may be stored at an address in the linked list storage memory 142 that corresponds to an address at which the corresponding one of the storage commands 124 is stored in the command buffer 138.

The logic of the system 100 may end by, for example, removing one or more of the storage commands 124 from one or more of the command queues 128 in response to completion of the storage command 124. The logic may include additional, different, or fewer operations than illustrated in FIG. 5. For example, prior to storage (410) of each of the storage commands 124 in the command buffer 138, the respective identifier 144 may be assigned to a respective one of the storage commands 124.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer readable storage media or circuits, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network. In yet other embodiments, the logic or instructions are stored within a given computer, central processing unit (“CPU”), graphics processing unit (“GPU”), or system.

Furthermore, although specific components are described above, methods, systems, and articles of manufacture consistent with the disclosure may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program, device, or apparatus. The components may be resident on separate hardware, such as separate removable circuit boards, or share common hardware, such as a same memory and processor for implementing instructions from the memory. Programs may be parts of a single program, separate programs, or distributed across several memories and processors.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A storage system comprising:
a command buffer configured to store a plurality of storage commands for a plurality of command queues;
a plurality of linked list controllers, wherein each one of the linked list controllers is configured to control a corresponding one of a plurality of linked lists, and each one of the linked lists is for a corresponding one of the command queues; and
a linked list storage memory configured to store a plurality of next command pointers for the storage commands stored in the command buffer,
wherein a linked list element in any of the linked lists includes one of the storage commands stored in the command buffer and a corresponding one of the next command pointers stored in the linked list storage memory, and
wherein the one of the storage commands and the corresponding one of the next command pointers are included in the linked list element based on a correspondence between an address at which the one of the storage commands is stored in the command buffer and an address at which the corresponding one of the next command pointers is stored in the linked list storage memory.

2. The storage system of claim 1, wherein the address at which the one of the storage commands is stored in the command buffer corresponds to the address at which the corresponding one of the next command pointers is stored in the linked list storage memory when the address at which the one of the storage commands is stored is equal to the address at which the corresponding one of the next command pointers is stored.

3. The storage system of claim 1, wherein each one of the linked list controllers comprises a head for the corresponding one of the linked lists, and the head identifies an address of a first storage command in the command buffer of the corresponding one of the command queues.

4. The storage system of claim 3, wherein the head identifies an address of a next command pointer in the linked list storage memory, and the next command pointer identifies an address of a second storage command of the corresponding one of the command queues.

5. The storage system of claim 1, wherein the linked list storage memory comprises an array of flip-flops that stores the next command pointers, each of next command pointers readable with a multiplexer that is selectively provided with an address at which a respective one of the next command pointers is stored in the linked list storage memory.

6. The storage of claim 1, wherein the command buffer is shared by the command queues.

7. An apparatus comprising:
a linked list storage memory configured to store a plurality of next command pointers for a plurality of storage commands that are stored in a command buffer,
wherein each one of the storage commands stored in the command buffer is queued in a respective one of a plurality of command queues, and each one of a plurality of linked lists identifies the storage commands that are in a corresponding one of the command queues,
wherein a linked list element in any of the linked lists includes a respective one of the storage commands stored in the command buffer and a corresponding one of the next command pointers stored in the linked list storage memory; and
a linked list controller configured to include the respective one of the storage commands and the corresponding one of the next command pointers in the linked list element based on storage of the corresponding one of the next command pointers in the linked list storage memory at an address that corresponds to an address of the one of the storage commands stored in the command buffer.

8. The apparatus of claim 7, wherein the linked list storage memory comprises a plurality of multiplexers, and each one of the multiplexers is configured to read any of the next command pointers that are stored in the linked list storage memory.

9. The apparatus of claim 8, wherein the multiplexers are configured to read the next command pointers within one clock cycle.

10. The apparatus of claim 7, wherein the linked list storage memory comprises a plurality of demultiplexers, and each one of the demultiplexers is configured to write any of the next command pointers to the linked list storage memory.

11. The apparatus of claim 10, wherein the demultiplexers are configured to write, concurrently with each other, any of the next command pointers.

12. The apparatus of claim 7, wherein the linked list storage memory comprises a flip flop array.

13. A method comprising:
storing storage commands in a command buffer when the storage commands are queued in a plurality of command queues;
storing a plurality of next command pointers in a linked list storage memory, wherein each respective one of the next command pointers identifies a storage command that follows a corresponding one of the storage commands in a corresponding one of the queues; and
associating each respective one of the next command pointers with the corresponding one of the storage commands by storing each respective one of the next command pointers at an address in the linked list storage memory that corresponds to an address at which the corresponding one of the storage commands is stored in the command buffer.

14. The method of claim 13 further comprising removing one of the storage commands from one of the queues by setting a tail in a linked list controller to a next command pointer in the linked list storage memory that corresponds to the one of the storage commands removed.

15. The method of claim 13 further comprising adding a storage command to one of the queues by setting a head in a linked list controller to an identifier of the storage command within the command buffer.

16. The method of claim 13 further comprising reading two or more of the next command pointers in one clock cycle from the linked list storage memory with a multiplexer.

17. The method of claim 13 further comprising writing two or more of the next command pointers to the linked list storage memory in one clock cycle with a demultiplexer.
